(19) United States
(12) Patent Application Publication
(10) Pub. No.: US 2020/0278700 A1
(43) Pub. Date: Sep. 3, 2020

(54) LOAD CONTROL METHOD AND DEVICE BASED ON UNMANNED AERIAL VEHICLE, AND UNMANNED AERIAL VEHICLE

(71) Applicant: GOERTEK TECHNOLOGY CO.,LTD., Qingdao City, Shandong (CN)

(72) Inventor: Chingshun LIN, Qingdao City (CN)

(73) Assignee: GOERTEK TECHNOLOGY CO.,LTD., Qingdao City, Shandong (CN)

(21) Appl. No.: 16/764,351

(22) PCT Filed: Dec. 18, 2017
(86) PCT No.: PCT/CN2017/117045

§ 371 Date: May 14, 2020

(30) Foreign Application Priority Data
Nov. 21, 2017 (CN) 201711166421.1

(51) Int. Cl. G05D 1/08; B64C 39/02; B64C 27/473; G01G 19/00

(52) U.S. Cl. CPC G05D 1/0816; B64C 39/024; B64C 2201/108; G01G 19/00; B64C 2201/027; B64C 27/473

(57) ABSTRACT

A load control method and device based on a UAV, and a UVA. The UVA includes: a UVA body, a propeller arm with a first end connected to the UVA body, a propeller blade connected to a second end of the propeller arm and a processor installed in the UVA body; a length of the propeller arm and a size of the propeller blade are adjustable. The control method includes: determining load gravity of the UVA based on a carrying object of the UVA; determining a target lift of the UVA based on the load gravity; determining a target size of the propeller blade and a target length of the propeller arm based on the target lift; and adjusting the propeller arm to the target length and the propeller blade to the target size, so that the UVA controls the propeller blade to rotate to carry the carrying object.

### TECHNICAL FIELD

The present disclosure relates to the field of intelligent control technology, and in particular to a load control method and device based on an unmanned aerial vehicle, and an unmanned aerial vehicle.

### BACKGROUND

Unmanned aerial vehicle (UAV for short) is a kind of unmanned aircraft that uses radio remote control, program control apparatus or computer control program to control flight. UAV may be applied to a variety of technical fields, such as agriculture, express transportation, disaster relief, etc. In these fields, the carrying capacity of the UAV is mainly used.

The UAV mainly uses the lift generated by the rotation of the propeller blade to transport the carrying object. The propeller blade is driven by the electric motor to generate lift. In the prior art, both the propeller blade and the propeller arm are fixedly mounted on the UAV, and sizes of the propeller blade and the propeller arm are fixed. Therefore, the lift generated by the propeller blade under the driving of the motor is also fixed.

In general, a UAV may carry a carrying object whose load gravity is less than its fixed lift. The load gravity generally refers to the sum of the gravity of the carrying object and the UAV body. However, if the load gravity carried by the UAV is small, the carrying can be achieved by using a lift less than the fixed lift provided by the UAV. The UAV carries the carrying object and the UVA body that are smaller than the lift of UAV, result in wasting of energy of the UAV.

### SUMMARY

In view of so, the present disclosure provides a load control method and device based on an unmanned aerial vehicle, and an unmanned aerial vehicle to solve the waste of the lift of the unmanned aerial vehicle caused by providing fixed lift and carrying object of different weights.

In order to solve the above technical problem, a first aspect of the present disclosure provides a load control method based on an unmanned aerial vehicle, and the unmanned aerial vehicle includes: an unmanned aerial vehicle body, a propeller arm with a first end connected to the unmanned aerial vehicle body, a propeller blade connected to a second end of the propeller arm and a processor installed in the unmanned aerial vehicle body; where a length of the propeller arm is adjustable, and a size of the propeller blade is adjustable;

the method includes:

determining load gravity of the unmanned aerial vehicle based on a carrying object of the unmanned aerial vehicle; determining a target lift of the unmanned aerial vehicle based on the load gravity; determining a target size of the propeller blade and a target length of the propeller arm based on the target lift; and adjusting the propeller arm to the target length and the propeller blade to the target size, so that the unmanned aerial vehicle controls the propeller blade to rotate to generate lift to carry the carrying object.

Preferably, the determining load gravity of the unmanned aerial vehicle based on a carrying object of the unmanned aerial vehicle includes:

controlling the propeller blade to adjust to a maximum size and the propeller arm to adjust to a maximum length, so that the unmanned aerial vehicle is in a first carrying state; utilizing the unmanned aerial vehicle in the first carrying state to carry the carrying object; determining a first lift of current of the unmanned aerial vehicle; and determining the load gravity of the unmanned aerial vehicle based on the first lift.

Preferably, the determining the load gravity of the unmanned aerial vehicle based on the first lift includes:

detecting whether a first carrying height of current of the unmanned aerial vehicle is greater than a preset height threshold value or not; if yes, determining the load gravity of the unmanned aerial vehicle based on the first lift and the first carrying height; if not, adjusting a rotation speed of the propeller blade until a second carrying height that is greater than the preset height threshold value is detected.

Preferably, the controlling the propeller arm to adjust to the target length and the propeller blade to adjust to the target size, so that the unmanned aerial vehicle controls the propeller blade to rotate to carry the carrying object includes:

determining an initial length of the propeller arm and an initial size of the propeller blade before adjustment; determining a first adjustment step of the propeller blade according to the target size and the initial size; determining a second adjustment step of the propeller arm according to the target length and the initial length; and controlling the propeller blade of the unmanned aerial vehicle to adjust the first adjustment step to the target size and the propeller arm to adjust the second adjustment step to the target length, so that the unmanned aerial vehicle controls the propeller blade to rotate to carry the carrying object.

A second aspect of the present disclosure provides a load control device based on an unmanned aerial vehicle, the control device is used to control an unmanned aerial vehicle and the unmanned aerial vehicle includes: an unmanned aerial vehicle body, a propeller arm with a first end connected to the unmanned aerial vehicle body, a propeller blade connected to a second end of the propeller arm and a processor installed in the unmanned aerial vehicle body; where a length of the propeller arm is adjustable, and a size of the propeller blade is adjustable;

the device includes: a processing component, and a storage component connected to the processing component; where the processing component includes one or more processors, the storage component includes one or more memories, and the storage component is for storing one or more computer instructions for the processing component to call and execute;

the processing component is for:

determining load gravity of the unmanned aerial vehicle based on a carrying object of the unmanned aerial vehicle; determining a target lift of the unmanned aerial vehicle based on the load gravity; determining a target size of the propeller blade and a target length of the propeller arm based on the target lift; and adjusting the propeller arm to the target length and the propeller blade to the target size, so that the unmanned aerial vehicle controls the propeller blade to rotate to generate lift to carry the carrying object.

Preferably, the processing component determining load gravity of the unmanned aerial vehicle based on a carrying object of the unmanned aerial vehicle specifically is:

controlling the propeller blade to adjust to a maximum size and the propeller arm to adjust to a maximum length, so that the unmanned aerial vehicle is in a first carrying state; utilizing the unmanned aerial vehicle in the first carrying state to carry the carrying object; determining a first lift of current of the unmanned aerial vehicle; and determining the load gravity of the unmanned aerial vehicle based on the first lift.

Preferably, the processing component determining the load gravity of the unmanned aerial vehicle based on the first lift specifically is:

detecting whether a first carrying height of current of the unmanned aerial vehicle is greater than a preset height threshold value or not; if yes, determining the load gravity of the unmanned aerial vehicle based on the first lift and the first carrying height; if not, adjusting a rotation speed of the propeller blade until a second carrying height that is greater than the preset height threshold value is detected, determining a second lift of the unmanned aerial vehicle after adjustment, and determining the load gravity of the unmanned aerial vehicle based on the second carrying height and the second lift.

Preferably, the processing component controlling the propeller arm to adjust to the target length and the propeller blade to adjust to the target size, so that the unmanned aerial vehicle controls the propeller blade to rotate to carry the carrying object specifically is:

determining an initial length of the propeller arm and an initial size of the propeller blade before adjustment; determining a first adjustment step of the propeller blade according to the target size and the initial size; determining a second adjustment step of the propeller arm according to the target length and the initial length; and controlling the propeller blade of the unmanned aerial vehicle to adjust the first adjustment step to the target size and the propeller arm to adjust the second adjustment step to the target length, so that the unmanned aerial vehicle controls the propeller blade to rotate to carry the carrying object.

A third aspect of the present disclosure provides an unmanned aerial vehicle, including an unmanned aerial vehicle body, a propeller arm with a first end connected to the unmanned aerial vehicle body, a propeller blade connected to a second end of the propeller arm and a processor installed in the unmanned aerial vehicle body to control the propeller blade to rotate to generate lift to carry a carrying object; where a length of the propeller arm is adjustable, and a size of the propeller blade is adjustable; and where a target size of the propeller blade and a target length of the propeller arm are determined according to a target lift determined by load gravity of the unmanned aerial vehicle.

Preferably, the processor of the unmanned aerial vehicle is further configured to:

determine the load gravity of the unmanned aerial vehicle based on the carrying object of the unmanned aerial vehicle; determine the target lift of the unmanned aerial vehicle based on the load gravity; determine the target size of the propeller blade and the target length of the propeller arm according to the target lift; and adjust the propeller arm to the target length and the propeller blade to the target size, so that the unmanned aerial vehicle controls the propeller blade to rotate to generate lift to carry the carrying object.

In the embodiment of the present disclosure, the load gravity of the unmanned aerial vehicle may be determined, the target lift of the unmanned aerial vehicle may be determined based on the load gravity, and the target size of the propeller blade and the target length of the propeller arm may be determined according to the target lift. After the propeller arm is controlled to adjust to the target length and the propeller blade is controlled to adjust to the target size, when the propeller blade is operated at the target size, a corresponding target lift may be generated correspondingly. The target lift is equivalent to the load gravity required to carry the carrying object, that is, the unmanned aerial vehicle may conduct carrying under a proper lift with the carrying object. Thereby the energy of the unmanned aerial vehicle may be used reasonably.

### BRIEF DESCRIPTION OF THE DRAWINGS

FIG. 1 is a flowchart of an embodiment of a control method based on an unmanned aerial vehicle according to an embodiment of the present disclosure;

FIG. 2 is a schematic diagram of a propeller blade with adjustable size according to an embodiment of the present disclosure;

FIG. 3 is a schematic diagram of a propeller arm with adjustable length according to an embodiment of the present disclosure;

FIG. 4 is a flowchart of still another embodiment of a control method based on an unmanned aerial vehicle according to an embodiment of the present disclosure;

FIG. 5 is a schematic structural diagram of an embodiment of a control device based on an unmanned aerial vehicle according to an embodiment of the present disclosure; and

FIG. 6 is a schematic diagram of an unmanned aerial vehicle according to an embodiment of the present disclosure.

### DETAILED DESCRIPTION OF EXAMPLE EMBODIMENTS

The implement of the present disclosure will be described in detail with reference to the accompanying drawings and embodiments, so as to fully understand and implement the implementation process of how to apply technical means to solve technical problems and achieve technical effects in the present disclosure.

The embodiment of the present invention is mainly applied to the control scenario of the unmanned aerial vehicle (UAV for short). By adjusting the size of the propeller blade of the UAV, the UAV may generate a lift equivalent to the gravity load, and energy waste may be avoided.

In the prior art, the fixed-size propeller arm and propeller blade are usually fixed on the UAV. The UAV mainly generates lift by the rotation of the propeller blade to transport a loading object (also called as carrying object). Therefore, when the propeller blade and the propeller arm are fixed, the lift generated by the UAV is also fixed when the rotation speed of the propeller blade is constant. When the blade and the arm of the propeller are fixed, the UAV may carry different carrying objects. At this time, the lift of the UAV carrying the carrying object is fixed. However, the gravity of different carrying objects is different, so the loading gravity needs to be carried by the UAV is different.

For example, suppose that the carrying objects are 30 KG and 10 KG respectively, and the gravity of the UAV body is 10 KG. The gravity that the UAV needs to carry is the sum of the gravity of the object gravity and the gravity of the UAV body, namely 400 N and 200 N respectively. The lift generated by the UAV is fixed at 500 N, and the lift is larger than the gravity that needs to be carried. When carrying a weight-less object, a lift equivalent to the fixed lifting force is not required. The UAV often converts into mechanical energy by batteries or fuels to control the propeller arm of the UAV to rotate to generate lift to carry the carrying object. When the lift of the UAV is fixed, the UAV needs to generate the corresponding power, and in order to generate power, the UAV needs to consume the corresponding energy. Therefore, when the propeller blade and the propeller arm of the UAV are fixed, a fixed power is generated, and when carrying objects with different weights, energy is wasted.

The inventor thinks that the lift generated by the UAV is not only related to the rotation speed of the propeller blade, but also to the size of the propeller blade. When the size of the propeller blade increases, the lift generated by the rotation of the propeller increases. In the case of a certain rotation speed, the size of the propeller blade may be adjusted. After the adjustment, the generated lift is adjusted accordingly, and the energy consumption is adjusted relatively. For example, it can be increased or decreased to meet the requirements of different weights of the carrying objects. The propeller blade is installed on the propeller arm. When adjusting the size of the propeller blade, the length of the propeller arm needs to be adjusted accordingly, so that the propeller blade may normally fly on the propeller arm, which increases the stability of the UAV.

Accordingly, the inventor has proposed the technical solution of the present disclosure.

In the embodiment of the present disclosure, the load gravity of the UAV is determined based on the carrying object of the UAV, to determine the target lift required to carry the carrying object. The target size of the propeller blade of the UAV and the target length of the propeller arm of the UAV may be determined according to the target lift. Thereby the propeller blade may be adjusted to the target size and the propeller arm may be adjusted to the target length. After adjustment, the propeller blade may generate lift corresponding to the load gravity to carry the carrying object. The lift of the UAV may adapt to the gravity of the carrying object, avoid the energy waste of the UAV caused by the fixed propeller blade and the fixed propeller arm, and make the energy consumption of the UAV more reasonable.

The technical solution of the present disclosure will be described in detail below with reference to the drawings.

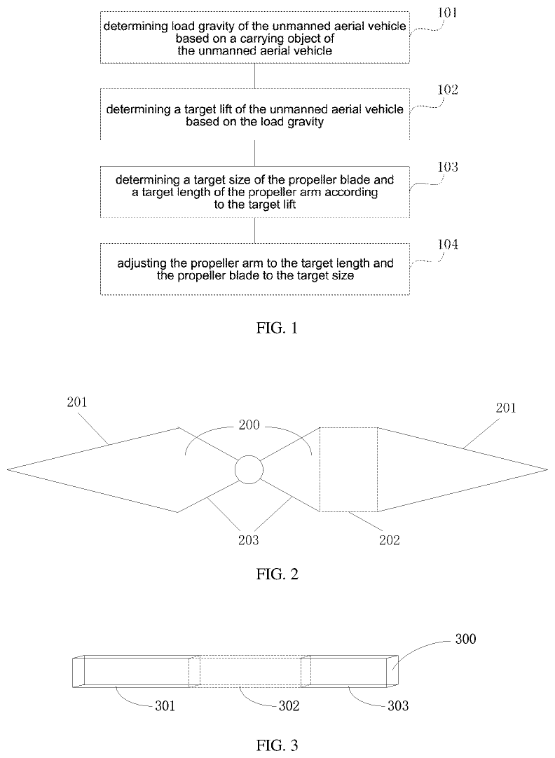

As shown in FIG. 1, it is a flowchart of an embodiment of a control method based on an unmanned aerial vehicle according to an embodiment of the present disclosure. The method may be mainly used to control an unmanned aerial vehicle (UAV for short). The UAV may include: a UAV body, a propeller arm with a first end connected to the UAV, where a length of the propeller arm is adjustable, a propeller blade connected to a second end of the propeller arm, where a size of the propeller blade is adjustable, and a processing component installed in the UAV body.

The method may include the following steps:

101: determining load gravity of the unmanned aerial vehicle based on a carrying object of the unmanned aerial vehicle.

UAV refers to a kind of unmanned aircraft controlled by radio remote control equipment and a self-provided program control apparatus. UAV may be used for carrying loads, which is widely used in express transportation, disaster relief, and material delivery. When the UAV is under load, the loaded object may be placed in the body of the UAV, or suspended from the UAV. The loading mode of the UAV is not limited here. Any mode for carrying an object by a human machine can belong to the embodiment of the present disclosure.

The load of a UAV is usually composed of the UAV body and a carrying object, and the load gravity of the UAV may be a sum of the gravity of the UAV body and the gravity of the carrying object.

Optionally, the load gravity of the UAV may be obtained by measuring with a gravity measuring instrument, or by measuring the weight of the UAV and the carrying object by a weight measurer, and calculating the product of the weight and the acceleration of gravity by Newton's mechanical constant force, which is the load gravity of the UAV.

A propeller is usually installed on the UAV. The propeller may include a propeller blade and a propeller arm. When the propeller blade rotates, lift is generated which enables the UAV to fly normally. The propeller blade may rotate in air or water to generate lift or propulsive force, and the blade may be a spiral structure. Generally, the lift generated when the propeller blade rotates may be related to its size and rotation speed, and both are proportional. When the size or the rotation speed of the propeller blade increases, the generated lift increases. The increase in the size of the propeller arm may mean that the area of the propeller blade may gradually increase according to a certain rule.

The propeller arm refers to a section of a support body having a supporting function connecting the UAV and the propeller blade, which may be a structure of long rectangular form or a long cylindrical form. When the area of the propeller blade increases, the propeller arm may be increased to ensure that the propeller blade may rotate normally without causing blade collision and affecting the normal use of the UAV. When the area of the propeller blade decreases, the propeller arm may be shortened to ensure the normal rotation of the propeller blade, and to avoid the phenomenon that the UAV is easily out of balance due to an overlong of the propeller arm.

The propeller blade being adjustable means that the area of the propeller blade is adjustable. The propeller arm being adjustable means that the length of the propeller arm is adjustable. The propeller blade and the propeller arm may be adjusted under the control of the UAV.

Optionally, the determining carrying gravity (also called as load gravity) of the unmanned aerial vehicle based on a carrying object of the unmanned aerial vehicle may include:

determining the body gravity of the UAV body and the object gravity of a load object (also called as carrying object); and

calculating the sum of the body gravity and the object gravity, which is the carrying gravity of the UAV.

102: determining a target lift of the unmanned aerial vehicle based on the load gravity.

The UAV is used to carry the carrying object, and when carrying the carrying object, it needs a corresponding target lift to carry the carrying object, so that the lift generated by the UAV is equivalent to the target lift, which may carry the carrying object.

The target lift of the UAV refers to the driving force (also called as propulsive force) that the UAV needs to generate when it can carry the carrying object to a certain height. Considering the reasons such as air resistance, the target lift force may be greater than the load gravity.

The UAV is also susceptible to environmental factors such as atmospheric pressure and atmospheric density during flight. The impact of these environmental factors is commonly referred to as the lift tolerance δ. The lift tolerance may be obtained by testing in advance. When considering the influence of environmental factors, the theoretical lift of the UAV is Y≥G+δ; where G is the carrying gravity of the UAV and δ is the lift tolerance.

103: determining a target size of the propeller blade and a target length of the propeller arm according to the target lift.

The larger the size of the propeller blade, the greater the lift force is generated when the propeller blade rotates at a certain speed. The target lift is affected by multiple factors, which may include: lift coefficient, the rotation speed of the propeller blade, atmospheric density, gravity, and the size of the propeller blade. With the same lift coefficient, the rotation speed of the propeller blade, the atmospheric density, and gravity, the target lift is proportional to the size of the propeller blade.

Optionally, the size of the propeller blade may refer to a target area of the propeller blade. The determining the target size of the propeller blade according to the target lift may include:

determining a target lift formula: Y=½ρCSv²; where Y is the target lift, C is the lift coefficient, v is the motor rotation speed, ρ is the atmospheric density, and S is the size of the propeller blade; and

calculating to obtain the size of propeller blade S by putting the values of the lift coefficient, the rotation speed of the propeller blade, the atmospheric density and the target lift into the above-mentioned target lift formula after the lift coefficient, the rotation speed of the propeller blade (since the propeller blade is driven by the motor to rotate, the rotation speed of the propeller blade and the motor rotation speed are equal) and the atmospheric density are determined.

The above-mentioned values of the lift coefficient, the motor rotation speed, and atmospheric density may be obtained through setting, measurement, and the like, and the obtaining modes are conventional ones, and will not be repeated here.

When the propeller blade is determined as the target size, a user may find a propeller blade that matches the target size, and install the propeller blade on the propeller arm whose length is adjusted to make the propeller blade is able to rotate on the propeller arm.

104: adjusting the propeller arm to the target length and the propeller blade to the target size, so that the unmanned aerial vehicle controls the propeller blade to rotate to generate lift to carry the carrying object.

The target size and the target length are respectively used to adjust the propeller blade and the propeller arm of the UAV. The UAV may adjust the propeller arm and the propeller blade according to the target size and the target length.

The propeller blade may be in the shape of a rhomboid, a streamline, etc. The spiral blade (also called as propeller blade) may include a first blade region, a second blade region, and a first adjustment mechanism with a first end connected to the first blade region and a second end connected to the second blade region. As shown in FIG. 2, it is a spiral blade 200 in the shape of a rhomboid, which may include a first blade region 201, a first adjustment mechanism 202, and a second blade region 203.

Optionally, the target size may include a target area, and the length of the propeller blade may be determined according to the target area, and the propeller blade may be adjusted according to the length of the propeller blade.

The propeller arm is adjustable, and the propeller arm may be in a long rectangular structure, and may include a first arm region, a second arm region, and a second adjustment mechanism with a first end connected to the first arm region and a second end connected to the second arm region. As shown in FIG. 3, it is a propeller arm 300 in a long rectangular shape, which may include a first arm region 301, a second adjustment mechanism 302, and a second arm region 303.

In the embodiment of the present disclosure, the load gravity of the UAV may be determined by the carrying object of the UAV, and the target lift of the UAV may be determined based on the load gravity, and the target size of the propeller blade and the target length of the propeller arm are determined according to the target lift. After the propeller arm is controlled to be adjusted to the target length and the propeller blade is controlled to be adjusted to the target length, when the propeller blade is operated at the target size, a corresponding target lift may be generated correspondingly, so that the target lift is equivalent to the load gravity required to carry the carrying object, that is, the UAV may perform carrying under a proper lift with the carrying object, and the energy of the UAV may be used reasonably.

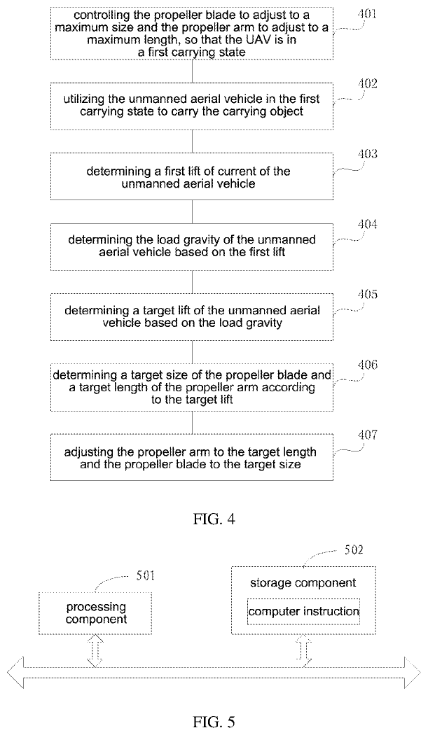

As shown in FIG. 4, it is a flowchart of still another embodiment of a load control method based on an unmanned aerial vehicle according to an embodiment of the present disclosure. The carrying method in the present embodiment may include:

401: controlling the propeller blade to adjust to a maximum size and the propeller arm to adjust to a maximum length, so that the UAV is in a first carrying state.

When the propeller blade is adjusted to the maximum size, a relatively maximum lift may be generated under the condition that the rotation speed is unchanged, and it can be determined whether the UAV can carry the carrying object at the rotation speed.

Optionally, the controlling the propeller blade to adjust to the maximum size may refer to controlling the UAV to adjust the propeller blade to the maximum size, and adjust the propeller arm to the maximum extent.

402: utilizing the unmanned aerial vehicle in the first carrying state to carry the carrying object.

Where, when the UAV is in the first carrying state, the propeller blade rotates at a first rotation speed to generate lift to carry the carrying object, and the rotation speed does not change during the carrying.

403: determining a first lift of current of the unmanned aerial vehicle.

The first lift of current of the UAV may be obtained by a lift calculation formula. When the propeller blade is at the maximum size, its size may be represented by M1. Assuming that the first rotation speed is v at this time, the first lift generated by UAV is Y1 may be calculated using the following lift calculation formula:

Y1=½ρC(M1)v²; formula 1

Where, Y1 is the first lift, C is the lift coefficient, v is the first rotation speed, ρ is the atmospheric density, and M1 is the size of the propeller blade.

404: determining the load gravity of the unmanned aerial vehicle based on the first lift.

As a possible implementation manner, the determining the load gravity of the UAV based on the first lift may include:

detecting whether a first carrying height of current of the unmanned aerial vehicle is greater than a preset height threshold value or not.

if yes, determining the load gravity of the unmanned aerial vehicle based on the first lift and the first carrying height;

if not, adjusting a rotation speed of the propeller blade until a second carrying height that is greater than the preset height threshold value is detected.

Optionally, the first lift of the UAV may be related to the load gravity and the first carrying height at which the current UAV is located. A distance detection component may be installed in the UAV to detect the height at which the UAV is located. The distance detection component may be a GPS positioning component, an infrared distance sensor, and the like.

Assuming that the first carrying height is H1, a flight conversion coefficient of the UAV is θ, the first lift is Y1, and the carrying gravity of the UAV is G, then the first carrying height at this time may be calculated by the following formula:

H1=θ*(Y1−G); formula 2

Formula 2 may be converted to obtain the formula for calculating the carrying gravity of the UAV:

G=Y1−H1/θ; formula 3

Putting the calculation formula of Y1 into the formula 3 to obtain the calculation formula of the UAV carrying gravity:

G=½ρC(M1)v²−H1/θ; formula 4

Where C is the lift coefficient, v is the first rotation speed, ρ is the atmospheric density, M1 is the size of the propeller blade, H1 is the first carrying height, and θ is the flight conversion coefficient of the UAV.

Optionally, after adjusting the rotation speed of the propeller blade, the second rotation speed adjusted by the UAV may be recorded. When the UAV is carrying the same or similar weight as the carrying object, the target rotation speed may be set to the second rotation speed. The rotation speed of the UAV may be manually set by the user and input from a UAV or a man-machine interaction interface provided by the load control device based on the UAV before carrying. When recording the second speed, the load gravity may also be recorded in correspondence with the second speed. Therefore, a corresponding relationship between the carrying gravity of the UAV and the rotation speed may be search in real time according to the corresponding relationship between the carried weight and the second rotation speed recorded in the carrying history, to obtain the corresponding rotation speed, and use the rotation speed as the first rotation speed to detect whether the lift generated by the propeller blade at this rotation speed is sufficient to carry the carrying object at this time.

When the first carrying height is less than the preset height, it means that at this time, even if the propeller blade is at the maximum size, it rotates at the first rotation speed, and the lift generated is insufficient to carry the carrying object. Therefore, it is necessary to increase the rotation speed of the propeller blade to the second rotation speed.

405: determining a target lift of the unmanned aerial vehicle based on the load gravity.

406: determining a target size of the propeller blade and a target length of the propeller arm according to the target lift.

407: adjusting the propeller arm to the target length and the propeller blade to the target size, so that the unmanned aerial vehicle controls the propeller blade to rotate to generate lift to carry the carrying object.

Some steps in the present embodiment of the present disclosure are the same as those shown in FIG. 1, which are not repeated herein.

In the embodiment of the present disclosure, when determining the load gravity of the UAV, the propeller blade of the UAV may be controlled to adjust to the maximum size and the propeller arm may be controlled to adjust to the maximum length, so that the UAV is in the first state as claimed. At this time, the UAV is used to carry the carrying object, the first lift of current of the UAV may be determined at this time to determine the load gravity of the UAV according to the first lift of the UAV. The load gravity of the UAV may be determined by the UAV's carrying process, to determine whether the lift generated by the UAV is sufficient to carry the carrying object, and then determine whether there is a need to adjust the propeller blade and the propeller arm. Thereby the load control process of the UAV is more accurate and a blind adjustment is avoided.

As yet another embodiment, the controlling the propeller arm adjust to a target length and the propeller blade to adjust to the target size, so that the unmanned aerial vehicle controls the propeller blade to rotate to carry the carrying object may include:

determining an initial length of the propeller arm and an initial size of the propeller blade before adjustment;

determining a first adjustment step of the propeller blade according to the target size and the initial size;

determining a second adjustment step of the propeller arm according to the target length and the initial length; and

controlling the propeller blade of the unmanned aerial vehicle to adjust the first adjustment step to the target size and the propeller arm to adjust the second adjustment step to the target length, so that the unmanned aerial vehicle controls the propeller blade to rotate to carry the carrying object.

The propeller blade and the propeller arm may be adjusted in size and length under the control of a drive motor. It is possible to determine a first adjustment accuracy of the propeller blade for each adjustment step driven by the first drive motor, and a second adjustment accuracy of the propeller arm for each adjustment step driven by the second drive motor.

The determining the first adjustment step of the propeller blade according to the target size and the initial size may include:

determining a first length of the propeller blade corresponding to the target size, and a second length of a propeller blade corresponding to the target size;

calculating a difference between the first length and the second length to obtain a first difference value; and

calculating a quotient of the first difference value and the first adjustment accuracy, and the sum of the rounded value and the integer 1 is the first adjustment step of the propeller blade.

The determining the second adjustment step of the propeller arm according to the target length and the initial length may include:

calculating a difference between the target length and the initial length, to obtain a second difference value; and

calculating a quotient of the second difference value and the second adjustment accuracy, and the sum of the rounded value and the integer 1 is the second adjustment step of the propeller blade.

In the embodiment of the present disclosure, when adjusting the propeller blade and the propeller arm, the first adjustment step may be calculated according to the initial size and the target size of the propeller blade, and the second adjustment step may be calculated according to the initial length and the target length of the propeller arm. By calculating the adjustment step, the propeller blade of the UAV may be controlled to adjust the corresponding first step, and the propeller arm of the UAV may be controlled to adjust to the corresponding second step, to improve the accuracy of the adjustment.

As yet another embodiment, the determining the target lift of the unmanned aerial vehicle based on the load gravity may include:

determining a target cruise altitude of the unmanned aerial vehicle; and

calculating the target lift of the unmanned aerial vehicle based on the target cruise altitude and the load gravity of the unmanned aerial vehicle.

Optionally, the target lift of the UAV may be calculated in accordance with the flight altitude conversion coefficient of the UAV, based on the target cruise altitude and the load gravity of the UAV.

Assuming that the flight altitude conversion coefficient is θ, the target cruise altitude is H2, the load gravity of the UAV is G , and the target lift of the UAV is Y2;

The target cruise altitude H2 may be expressed by the following formula:

H2=θ(Y2−G); formula 5

By formula conversion, the formula for calculating the target lift of the UAV may be obtained:

Y2=H2/θ+G; formula 6

The target lift Y2 may be calculated by putting the target cruise altitude H2, the flight altitude conversion coefficient θ, and the load gravity G into formula 6.

Optionally, after calculating the target lift, the target size of the propeller blade may be determined by the target lift.

The target lift Y2 may be expressed by the lift formula: Y=½ρpCSv²; where Y is the target lift, C is the lift coefficient, v is the motor rotation speed, ρ is the atmospheric density, S is the size of the propeller blade, and target lift Y2 may be expressed by the lift formula as Y1=½ρCM2v², where M2 is the unknown target size of the propeller blade.

In the embodiment of the present disclosure, the lift of the UAV may be related to its cruise altitude, and the target lift of the UAV determined by the cruise altitude may control the calculation process of the target lift to be more accurate. It may make the UAV to generate enough the lift to carry to the target cruise altitude, and avoid the inaccurate flight altitude caused by the insufficient UAV lift caused by the estimation method.

It should be noted that the load control device based on the UAV described in the embodiment of the present disclosure may be a control device based on the UAV, for example, a UAV remote control. It may also be a general computing device that is different from the UAV and its control device, for example, a notebook. The computing device may perform data communication with the control device of the UAV or a processor inside the UAV body to transfer the target size and the target length to the UAV to control the UAV to carry a load object, or obtain various data of the UAV from the UAV, such as sensing data of the UAV. It may also be a module device located on the UAV, that is, a module in which the above-mentioned load control device based on the UAV is configured in the UAV.

As shown in FIG. 5, it is a load control device based on an unmanned aerial vehicle according to an embodiment of the present disclosure, the control device is used to control the UAV, and the UAV includes: a UAV body, a propeller arm with a first end connected to the UAV, where a length of the propeller arm is adjustable, a propeller blade connected to a second end of the propeller arm, where a size of the propeller blade is adjustable, and a processing component installed in the UAV body.

The device includes: a processing component 501, and a storage component 502 connected to the processing component; where the processing component 501 includes one or more processors, and the storage component 502 includes one or more memories, and the storage component is for storing one or more computer instructions for the processing component to call and execute;

The processing component 501 may be for:

determining load gravity of the unmanned aerial vehicle based on a carrying object of the unmanned aerial vehicle; determining a target lift of the unmanned aerial vehicle based on the load gravity; determining a target size of the propeller blade and a target length of the propeller arm based on the target lift; and adjusting the propeller arm to the target length and the propeller blade to the target size, so that the unmanned aerial vehicle controls the propeller blade to rotate to generate lift to carry the carrying object.

Optionally, the control device may be a control device independent of the UAV. The control device may include a display component, which may display a control process and control data of the UAV. The display component may be a touchable display screen. At this time, the display component may also be used to input various data of the UAV, for example, the initial rotation speed of the UAV.

UAV refers to a kind of unmanned aircraft controlled by radio remote control equipment and a self-provided program control apparatus. UAV may be used for carrying loads, which is widely used in express transportation, disaster relief, and material delivery. When the UAV is under load, the loaded object may be placed in the body of the UAV, or suspended from the UAV. The loading mode of the UAV is not limited here. Any mode for carrying an object by a human machine can belong to the embodiment of the present disclosure.

The load of a UAV is usually composed of the UAV body and a carrying object, and the load gravity of the UAV may be a sum of the gravity of the UAV body and the gravity of the carrying object.

Optionally, the load gravity of the UAV may be obtained by measuring with a gravity measuring instrument, or by measuring the weight of the UAV and the carrying object by a weight measurer, and calculating the product of the weight and the acceleration of gravity by Newton's mechanical constant force, which is the load gravity of the UAV.

A propeller is usually installed on the UAV. The propeller may include a propeller blade and a propeller arm. When the propeller blade rotates, lift is generated which enables the UAV to fly normally. The propeller blade may rotate in air or water to generate lift or propulsive force, and the blade may be a spiral structure. Generally, the lift generated when the propeller blade rotates may be related to its size and rotation speed, and both are proportional. When the size or the rotation speed of the propeller blade increases, the generated lift increases. The increase in the size of the propeller arm may mean that the area of the propeller blade may gradually increase according to a certain rule.

The propeller arm refers to a section of a support body having a supporting function connecting the UAV and the propeller blade, which may be a structure of long rectangular form or a long cylindrical form. When the area of the propeller blade increases, the propeller arm may be increased to ensure that the propeller blade may rotate normally without causing blade collision and affecting the normal use of the UAV. When the area of the propeller blade decreases, the propeller arm may be shortened to ensure the normal rotation of the propeller blade, and to avoid the phenomenon that the UAV is easily out of balance due to an overlong of the propeller arm.

The propeller blade being adjustable means that the area of the propeller blade is adjustable. The propeller arm being adjustable means that the length of the propeller arm is adjustable. The propeller blade and the propeller arm may be adjusted under the control of the UAV.

Optionally, the determining carrying gravity of the unmanned aerial vehicle based on a carrying object of the unmanned aerial vehicle may include:

determining the body gravity of the UAV body and the object gravity of the load object; and

calculating the sum of the body gravity and the object gravity, which is the carrying gravity of the UAV.

The UAV is used to carry the carrying object, and when carrying the carrying object, it needs a corresponding target lift to carry the carrying object, so that the lift generated by the UAV is equivalent to the target lift, which may carry the carrying object.

The target lift of the UAV refers to the driving force that the UAV needs to generate when it can carry the carrying object to a certain height. Considering the reasons such as air resistance, the target lift force may be greater than the load gravity.

The UAV is also susceptible to environmental factors such as atmospheric pressure and atmospheric density during flight. The impact of these environmental factors is commonly referred to as the lift tolerance δ. The lift tolerance may be obtained by testing in advance. When considering the influence of environmental factors, the theoretical lift of the UAV is Y≥G+δ; where G is the carrying gravity of the UAV and δ is the lift tolerance.

The larger the size of the propeller blade, the greater the lift force is generated when the propeller blade rotates at a certain speed. The target lift is affected by multiple factors, which may include: lift coefficient, the rotation speed of the propeller blade, atmospheric density, gravity, and the size of the propeller blade. With the same lift coefficient, the rotation speed of the propeller blade, the atmospheric density, and gravity, the target lift is proportional to the size of the propeller blade.

Optionally, the size of the propeller blade may refer to a target area of the propeller blade. The determining the target size of the propeller blade according to the target lift may include:

determining a target lift formula: Y=½ρCSv²; where Y is the target lift, C is the lift coefficient, v is the motor rotation speed, ρ is the atmospheric density, and S is the size of the propeller blade; and

calculating to obtain the size of propeller blade S by putting the values of the lift coefficient, the rotation speed of the propeller blade, the atmospheric density and the target lift into the above-mentioned target lift formula after the lift coefficient, the rotation speed of the propeller blade and the atmospheric density are determined.

The above-mentioned values of the lift coefficient, the motor rotation speed, and atmospheric density may be obtained through setting, measurement, and the like, and the obtaining modes are conventional ones, and will not be repeated here.

When the propeller blade is determined as the target size, a user may find a propeller blade that matches the target size, and install the propeller blade on the propeller arm whose length is adjusted to make the propeller blade is able to rotate on the propeller arm.

The target size and the target length are respectively used to adjust the propeller blade and the propeller arm of the UAV. The UAV may adjust the propeller arm and the propeller blade according to the target size and the target length.

The propeller blade may be in the shape of a rhomboid, a streamline, etc. The spiral blade may include a first blade region, a second blade region, and a first adjustment mechanism with a first end connected to the first blade region and a second end connected to the second blade region.

Optionally, the target size may include a target area, and the length of the propeller blade may be determined according to the target area, and the propeller blade may be adjusted according to the length of the propeller blade.

The propeller arm is adjustable, and the propeller blade may be in a long rectangular structure, and may include a first arm region, a second arm region, and a second adjustment mechanism with a first end connected to the first blade region and a second end connected to the second blade region.

Optionally, the device may transfer the target size and the target length to the UAV to control the UAV to adjust according to the target size and the target length. The device may further determine a blade control command of the propeller blade and a arm control command of the propeller arm according to the target size and the target length, and transfer the blade control command and the arm control command to the UAV, so that the UAV responds to the blade control command and the arm control command to adjust the propeller arm to the target length and the propeller blade to the target size.

In the embodiment of the present disclosure, the load gravity of the UAV may be determined by the carrying object of the UAV, and the target lift of the UAV may be determined based on the load gravity, and the target size of the propeller blade and the target length of the propeller arm are determined according to the target lift. After the propeller arm is controlled to be adjusted to the target length and the propeller blade is controlled to be adjusted to the target length, when the propeller blade is operated at the target size, a corresponding target lift may be generated correspondingly, so that the target lift is equivalent to the load gravity required to carry the carrying object, that is, the UAV may perform carrying under a proper lift with the carrying object, and the energy of the UAV may be used reasonably.

As an embodiment, the processing component determines the load gravity of the UAV based on the carrying object of the UAV, which may specifically be:

controlling the propeller blade to adjust to a maximum size and the propeller arm to adjust to a maximum length, so that the unmanned aerial vehicle is in a first carrying state; utilizing the unmanned aerial vehicle in the first carrying state to carry the carrying object; determining a first lift of current of the unmanned aerial vehicle; and determining the load gravity of the unmanned aerial vehicle based on the first lift.

When the propeller blade is adjusted to the maximum size, a relatively maximum lift may be generated under the condition that the rotation speed is unchanged, and it can be determined whether the UAV can carry the carrying object at the rotation speed.

Optionally, the controlling the propeller blade to adjust to the maximum size may refer to controlling the UAV to adjust the propeller blade to the maximum size, and adjust the propeller arm to the maximum extent.

Where, when the UAV is in the first carrying state, the propeller blade rotates at a first rotation speed to generate lift to carry the carrying object, and the rotation speed does not change during the carrying.

The first lift of current of the UAV may be obtained by a lift calculation formula. When the propeller blade is at the maximum size, its size may be represented by M1. Assuming that the first rotation speed is v at this time, the first lift generated by UAV is Y1 may be calculated using the following lift calculation formula:

Y1=½ρC(M1)v²; formula 1

Where, Y1 is the first lift, C is the lift coefficient, v is the first rotation speed, ρ is the atmospheric density, and M1 is the size of the propeller blade.

As a possible implementation manner, the determining the load gravity of the UAV based on the first lift may specifically be:

detecting whether a first carrying height of current of the unmanned aerial vehicle is greater than a preset height threshold value or not.

if yes, determining the load gravity of the unmanned aerial vehicle based on the first lift and the first carrying height;

if not, adjusting a rotation speed of the propeller blade until a second carrying height that is greater than the preset height threshold value is detected.

Optionally, the first lift of the UAV may be related to the load gravity and the first carrying height at which the current UAV is located. A distance detection component may be installed in the UAV to detect the height at which the UAV is located. The distance detection component may be a GPS positioning component, an infrared distance sensor, and the like.

Assuming that the first carrying height is H1, a flight conversion coefficient of the UAV is η, the first lift is Y1, and the carrying gravity of the UAV is G, then the first carrying height at this time may be calculated by the following formula:

H1=θ*(Y1−G) formula 2

Formula 2 may be converted to obtain the formula for calculating the carrying gravity of the UAV:

G=Y1−H1/θ; formula 3

Putting the calculation formula of Y1 into the formula 3 to obtain the calculation formula of the UAV carrying gravity:

G=½ρC(M1)v²−H1/θ; formula 4

Where C is the lift coefficient, v is the first rotation speed, ρ is the atmospheric density, M1 is the size of the propeller blade, H1 is the first carrying height, and θ is the flight conversion coefficient of the UAV.

Optionally, after adjusting the rotation speed of the propeller blade, the second rotation speed adjusted by the UAV may be recorded. When the UAV is carrying the same or similar weight as the carrying object, the target rotation speed may be set to the second rotation speed. The rotation speed of the UAV may be manually set by the user and input from a UAV or a man-machine interaction interface provided by the load control device based on the UAV before carrying. When recording the second speed, the load gravity may also be recorded in correspondence with the second speed. Therefore, a corresponding relationship between the carrying gravity of the UAV and the rotation speed may be search in real time according to the corresponding relationship between the carried weight and the second rotation speed recorded in the carrying history, to obtain the corresponding rotation speed, and use the rotation speed as the first rotation speed to detect whether the lift generated by the propeller blade at this rotation speed is sufficient to carry the carrying object at this time.

When the first carrying height is less than the preset height, it means that at this time, even if the propeller blade is at the maximum size, it rotates at the first rotation speed, and the lift generated is insufficient to carry the carrying object. Therefore, it is necessary to increase the rotation speed of the propeller blade to the second rotation speed.

In the embodiment of the present disclosure, when determining the load gravity of the UAV, the propeller blade of the UAV may be controlled to adjust to the maximum size and the propeller arm may be controlled to adjust to the maximum length, so that the UAV is in the first state as claimed. At this time, the UAV is used to carry the carrying object, the first lift of current of the UAV may be determined at this time to determine the load gravity of the UAV according to the first lift of the UAV. The load gravity of the UAV may be determined by the UAV's carrying process, to determine whether the lift generated by the UAV is sufficient to carry the carrying object, and then determine whether there is a need to adjust the propeller blade and the propeller arm. Thereby the load control process of the UAV is more accurate and a blind adjustment is avoided.

As yet another embodiment, the processing component controlling the propeller arm adjust to a target length and the propeller blade to adjust to the target size, so that the unmanned aerial vehicle controls the propeller blade to rotate to carry the carrying object may specifically be:

determining an initial length of the propeller arm and an initial size of the propeller blade before adjustment;

determining a first adjustment step of the propeller blade according to the target size and the initial size;

determining a second adjustment step of the propeller arm according to the target length and the initial length; and

controlling the propeller blade of the unmanned aerial vehicle to adjust the first adjustment step to the target size and the propeller arm to adjust the second adjustment step to the target length, so that the unmanned aerial vehicle controls the propeller blade to rotate to carry the carrying object.

The propeller blade and the propeller arm may be adjusted in size and length under the control of a drive motor. It is possible to determine a first adjustment accuracy of the propeller blade for each adjustment step driven by the first drive motor, and a second adjustment accuracy of the propeller arm for each adjustment step driven by the second drive motor.

The processing component determining the first adjustment step of the propeller blade according to the target size and the initial size may specifically be:

determining a first length of the propeller blade corresponding to the target size, and a second length of a propeller blade corresponding to the target size;

calculating a difference between the first length and the second length to obtain a first difference value; and

calculating a quotient of the first difference value and the first adjustment accuracy, and the sum of the rounded value and the integer 1 is the first adjustment step of the propeller blade.

The processing component determining the second adjustment step of the propeller arm according to the target length and the initial length may specifically be:

calculating a difference between the target length and the initial length, to obtain a second difference value; and

calculating a quotient of the second difference value and the second adjustment accuracy, and the sum of the rounded value and the integer 1 is the second adjustment step of the propeller blade.

In the embodiment of the present disclosure, when adjusting the propeller blade and the propeller arm, the first adjustment step may be calculated according to the initial size and the target size of the propeller blade, and the second adjustment step may be calculated according to the initial length and the target length of the propeller arm. By calculating the adjustment step, the propeller blade of the UAV may be controlled to adjust the corresponding first step, and the propeller arm of the UAV may be controlled to adjust to the corresponding second step, to improve the accuracy of the adjustment.

As yet another embodiment, the processing component determining the target lift of the unmanned aerial vehicle based on the load gravity may specifically be:

determining a target cruise altitude of the unmanned aerial vehicle; and

calculating the target lift of the unmanned aerial vehicle based on the target cruise altitude and the load gravity of the unmanned aerial vehicle.

Optionally, the target lift of the UAV may be calculated in accordance with the flight altitude conversion coefficient of the UAV, based on the target cruise altitude and the load gravity of the UAV.

Assuming that the flight altitude conversion coefficient is θ, the target cruise altitude is H2 , the load gravity of the UAV is G, and the target lift of the UAV is Y2;

The target cruise altitude H2 may be expressed by the following formula:

H2=θ(Y2−G); formula 5

By formula conversion, the formula for calculating the target lift of the UAV may be obtained:

Y2=H2/θ+G; formula 6

The target lift Y2 may be calculated by putting the target cruise altitude H2, the flight altitude conversion coefficient θ, and the load gravity G into formula 6.

Optionally, after calculating the target lift, the target size of the propeller blade may be determined by the target lift.

The target lift Y2 may be expressed by the lift formula: Y=½ρCSv²; where Y is the target lift, C is the lift coefficient, v is the motor rotation speed, ρ is the atmospheric density, S is the size of the propeller blade, and target lift Y2 may be expressed by the lift formula as Y1=½ρCM2v², where M2 is the unknown target size of the propeller blade.

In the embodiment of the present disclosure, the lift of the UAV may be related to its cruise altitude, and the target lift of the UAV determined by the cruise altitude may control the calculation process of the target lift to be more accurate. It may make the UAV to generate enough the lift to carry to the target cruise altitude, and avoid the inaccurate flight altitude caused by the insufficient UAV lift caused by the estimation method.

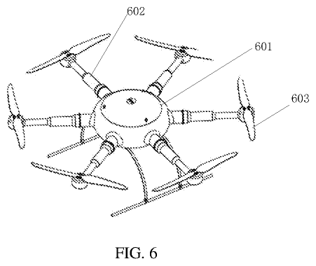

As shown in FIG. 6, it is a schematic structural diagram of an unmanned aerial vehicle according to an embodiment of the present disclosure. The UAV may include a UAV body 601, a propeller arm 602 with a first end connected to the UAV, where a length of the propeller arm is adjustable, a propeller blade 603 connected to a second end of the propeller arm, where a size of the propeller blade is adjustable, and a processor (not shown in the drawings) installed in the UAV body 601, to control the propeller blade to rotate to generated lift to carry the carrying object;

where a target size of the propeller blade and a target length of the propeller arm are determined according to a target lift determined by load gravity of the unmanned aerial vehicle.

The propeller blade may be in the shape of a rhomboid, a streamline, etc. The spiral blade may include a first blade region, a second blade region, and a first adjustment mechanism with a first end connected to the first blade region and a second end connected to the second blade region.

Optionally, the target size may include a target area, and the length of the propeller blade may be determined according to the target area, and the propeller blade may be adjusted according to the length of the propeller blade.

The propeller arm is adjustable, and the propeller blade may be in a long rectangular structure, and may include a first arm region, a second arm region, and a second adjustment mechanism with a first end connected to the first blade region and a second end connected to the second blade region.

The UAV may adjust the size of the propeller blade and the length of the propeller arm.

The UAV may include multiple propeller blades and propeller arms. The UAV shown in FIG. 6 is only a schematic diagram of an unmanned connection shown in the present disclosure. The shape and quantity of the propeller blade, the shape and quantity of the propeller arm and the shape of the UAV body are not limited to those shown in FIG. 6. When the propeller blade and the propeller arm are adjustable, they all belong to the technical solution descripted in the present disclosure.

In the embodiment of the present disclosure, the propeller blade and the propeller arm of the UAV may be adjusted, so that the carrying gravity of the UAV changes accordingly. Therefore the load range of the UAV may be extended, the use of itself is more reasonable, the power consumption of the UAV is saved and the energy is saved consequently.

As a possible implementation manner, the processor of the UAV may also be configured to:

determine the load gravity of the unmanned aerial vehicle based on the carrying object of the unmanned aerial vehicle;

determine the target lift of the unmanned aerial vehicle based on the load gravity;

determine the target size of the propeller blade and the target length of the propeller arm according to the target lift; and

adjust the propeller arm to the target length and the propeller blade to the target size, so that the unmanned aerial vehicle controls the propeller blade to rotate to generate lift to carry the carrying object.

The UAV may calculate a target size of the propeller blade and a target length of the propeller arm according to the obtained data, and then control a blade motor to adjust the size of the propeller blade and control a propeller arm motor to adjust the length of the propeller arm.

UAV refers to a kind of unmanned aircraft controlled by radio remote control equipment and a self-provided program control apparatus. UAV may be used for carrying loads, which is widely used in express transportation, disaster relief, and material delivery. When the UAV is under load, the loaded object may be placed in the body of the UAV, or suspended from the UAV. The loading mode of the UAV is not limited here. Any mode for carrying an object by a human machine can belong to the embodiment of the present disclosure.

The load of a UAV is usually composed of the UAV body and a carrying object, and the load gravity of the UAV may be a sum of the gravity of the UAV body and the gravity of the carrying object.

Optionally, the load gravity of the UAV may be obtained by measuring with a gravity measuring instrument, or by measuring the weight of the UAV and the carrying object by a weight measurer, and calculating the product of the weight and the acceleration of gravity by Newton's mechanical constant force, which is the load gravity of the UAV.

A propeller is usually installed on the UAV. The propeller may include a propeller blade and a propeller arm. When the propeller blade rotates, lift is generated which enables the UAV to fly normally. The propeller blade may rotate in air or water to generate lift or propulsive force, and the blade may be a spiral structure. Generally, the lift generated when the propeller blade rotates may be related to its size and rotation speed, and both are proportional. When the size or the rotation speed of the propeller blade increases, the generated lift increases. The increase in the size of the propeller arm may mean that the area of the propeller blade may gradually increase according to a certain rule.

The propeller arm refers to a section of a support body having a supporting function connecting the UAV and the propeller blade, which may be a structure of long rectangular form or a long cylindrical form. When the area of the propeller blade increases, the propeller arm may be increased to ensure that the propeller blade may rotate normally without causing blade collision and affecting the normal use of the UAV. When the area of the propeller blade decreases, the propeller arm may be shortened to ensure the normal rotation of the propeller blade, and to avoid the phenomenon that the UAV is easily out of balance due to an overlong of the propeller arm.

The propeller blade being adjustable means that the area of the propeller blade is adjustable. The propeller arm being adjustable means that the length of the propeller arm is adjustable. The propeller blade and the propeller arm may be adjusted under the control of the UAV.

Optionally, the processor determines carrying gravity of the unmanned aerial vehicle based on a carrying object of the unmanned aerial vehicle may be:

determining the body gravity of the UAV body and the object gravity of the load object; and

calculating the sum of the body gravity and the object gravity, which is the carrying gravity of the UAV.

The UAV is used to carry the carrying object, and when carrying the carrying object, it needs a corresponding target lift to carry the carrying object, so that the lift generated by the UAV is equivalent to the target lift, which may carry the carrying object.

The target lift of the UAV refers to the driving force that the UAV needs to generate when it can carry the carrying object to a certain height. Considering the reasons such as air resistance, the target lift force may be greater than the load gravity.

The UAV is also susceptible to environmental factors such as atmospheric pressure and atmospheric density during flight. The impact of these environmental factors is commonly referred to as the lift tolerance δ. The lift tolerance may be obtained by testing in advance. When considering the influence of environmental factors, the theoretical lift of the UAV is Y≥G+δ; where G is the carrying gravity of the UAV and δ is the lift tolerance.

The larger the size of the propeller blade, the greater the lift force is generated when the propeller blade rotates at a certain speed. The target lift is affected by multiple factors, which may include: lift coefficient, the rotation speed of the propeller blade, atmospheric density, gravity, and the size of the propeller blade. With the same lift coefficient, the rotation speed of the propeller blade, the atmospheric density, and gravity, the target lift is proportional to the size of the propeller blade.

Optionally, the size of the propeller blade may refer to a target area of the propeller blade. The processor determines the target size of the propeller blade according to the target lift may specifically be:

determining a target lift formula: Y=½ρCSv²; where Y is the target lift, C is the lift coefficient, v is the motor rotation speed, ρ is the atmospheric density, and S is the size of the propeller blade; and

calculating to obtain the size of propeller blade S by putting the values of the lift coefficient, the rotation speed of the propeller blade, the atmospheric density and the target lift into the above-mentioned target lift formula after the lift coefficient, the rotation speed of the propeller blade and the atmospheric density are determined.

The above-mentioned values of the lift coefficient, the motor rotation speed, and atmospheric density may be obtained through setting, measurement, and the like, and the obtaining modes are conventional ones, and will not be repeated here.

When the propeller blade is determined as the target size, a user may find a propeller blade that matches the target size, and install the propeller blade on the propeller arm whose length is adjusted to make the propeller blade is able to rotate on the propeller arm.

The target size and the target length are respectively used to adjust the propeller blade and the propeller arm of the UAV. The UAV may adjust the propeller arm and the propeller blade according to the target size and the target length.

The propeller blade may be in the shape of a rhomboid, a streamline, etc. The spiral blade may include a first blade region, a second blade region, and a first adjustment mechanism with a first end connected to the first blade region and a second end connected to the second blade region.

Optionally, the target size may include a target area, and the length of the propeller blade may be determined according to the target area, and the propeller blade may be adjusted according to the length of the propeller blade.

The propeller arm is adjustable, and the propeller blade may be in a long rectangular structure, and may include a first arm region, a second arm region, and a second adjustment mechanism with a first end connected to the first blade region and a second end connected to the second blade region.

Optionally, the device may transfer the target size and the target length to the UAV to control the UAV to adjust according to the target size and the target length. The device may further determine a blade control command of the propeller blade and a arm control command of the propeller arm according to the target size and the target length, and transfer the blade control command and the arm control command to the UAV, so that the UAV responds to the blade control command and the arm control command to adjust the propeller arm to the target length and the propeller blade to the target size.

Optionally, the UAV may further include: a blade motor and an arm motor; the UAV may calculate movement steps of the blade motor and the arm motor according to a target size of the propeller blade and a target length of the propeller arm, and generating a movement instruction according to the movement steps to control the blade motor to adjust the size and the arm motor to adjust the length.

In the embodiment of the present disclosure, the load gravity of the UAV may be determined by the carrying object of the UAV, and the target lift of the UAV may be determined based on the load gravity, and the target size of the propeller blade and the target length of the propeller arm are determined according to the target lift. After the propeller arm is controlled to be adjusted to the target length and the propeller blade is controlled to be adjusted to the target length, when the propeller blade is operated at the target size, a corresponding target lift may be generated correspondingly, so that the target lift is equivalent to the load gravity required to carry the carrying object, that is, the UAV may perform carrying under a proper lift with the carrying object, and the energy of the UAV may be used reasonably.

As an embodiment, the UAV may further include: a drive motor located at a second end of the propeller arm and connected to the propeller blade;

the processor specifically controls the driving motor to rotate to drive the propeller blade to rotate.

In the embodiment of the present disclosure, the propeller is driven by the driving motor in the UAV, and then the UAV may carry a load object, so that the use of the UAV is normalized.

As yet another embodiment, the UAV may further include: an environment detection component connected to the processor, for detecting current environmental information of the UAV;

The processor is further configured to:

determine current environmental information of the UAV; and calculate a target rotation speed of the propeller blade according to the current environmental information, the target size, and the target length;

the processor controlling the propeller blade to rotate specifically controls the propeller blade to rotate in accordance with the target rotation speed.

Optionally, the environment detection component may include a distance detector, a GPS locator, and the like.

In the embodiment of the present disclosure, by determining the environmental information of the UAV and adding the environmental information to carrying factors of the UAV, the target rotation speed of the UAV may be determined from multiple aspects, and the accuracy of operation of the UAV is improved, and the transport efficiency of the UAV is improve thereby.

As yet another embodiment, the UAV may further include a display component connected to the processor;

the processor is further configured to control the display component to output adjustment prompt information based on the target size and the target length; and the adjustment prompt information is used to prompt the user that the UAV has adjusted the propeller arm of the UAV and the propeller blade of the UAV has been replaced according to the target size.

As yet another embodiment, the UAV may further include an output component connected to the processor;

the processor is further configured to control the output component to output adjustment prompt information to a display device based on the target size and the target length.

The adjustment prompt information may include the target size and the target length. The user may replace the propeller blade of the UAV according to the target size, and the propeller arm may be adjusted according to the target length.

In the embodiment of the present disclosure, the display component may display prompt information, so that the user may obtain data information such as the target size and the target length in time, or may also prompt the user to adjust the propeller arm of the UAV and replace the propeller blade of the UAV, to enable the user to adjust the load of the UAV in time, so that the UAV may be adjusted for use and its use efficiency may be improved.

As an embodiment, the processor determines the load gravity of the UAV based on the carrying object of the UAV, which may specifically be:

controlling the propeller blade to adjust to a maximum size and the propeller arm to adjust to a maximum length, so that the unmanned aerial vehicle is in a first carrying state; utilizing the unmanned aerial vehicle in the first carrying state to carry the carrying object; determining a first lift of current of the unmanned aerial vehicle; and determining the load gravity of the unmanned aerial vehicle based on the first lift.

Where, when the UAV is in the first carrying state, the propeller blade rotates at a first rotation speed to generate lift to carry the carrying object, and the rotation speed does not change during the carrying.

As a possible implementation manner, the processor determines the load gravity of the UAV based on the first lift may specifically be:

detecting whether a first carrying height of current of the unmanned aerial vehicle is greater than a preset height threshold value or not.

if yes, determining the load gravity of the unmanned aerial vehicle based on the first lift and the first carrying height;

if not, adjusting a rotation speed of the propeller blade until a second carrying height that is greater than the preset height threshold value is detected.

Optionally, after adjusting the rotation speed of the propeller blade, the second rotation speed adjusted by the UAV may be recorded. When the UAV is carrying the same or similar weight as the carrying object, the target rotation speed may be set to the second rotation speed. The rotation speed of the UAV may be manually set by the user and input from a UAV or a man-machine interaction interface provided by the load control device based on the UAV before carrying. When recording the second speed, the load gravity may also be recorded in correspondence with the second speed. Therefore, a corresponding relationship between the carrying gravity of the UAV and the rotation speed may be search in real time according to the corresponding relationship between the carried weight and the second rotation speed recorded in the carrying history, to obtain the corresponding rotation speed, and use the rotation speed as the first rotation speed to detect whether the lift generated by the propeller blade at this rotation speed is sufficient to carry the carrying object at this time.

When the first carrying height is less than the preset height, it means that at this time, even if the propeller blade is at the maximum size, it rotates at the first rotation speed, and the lift generated is insufficient to carry the carrying object. Therefore, it is necessary to increase the rotation speed of the propeller blade to the second rotation speed.

In the embodiment of the present disclosure, when determining the load gravity of the UAV, the propeller blade of the UAV may be controlled to adjust to the maximum size and the propeller arm may be controlled to adjust to the maximum length, so that the UAV is in the first state as claimed. At this time, the UAV is used to carry the carrying object, the first lift of current of the UAV may be determined at this time to determine the load gravity of the UAV according to the first lift of the UAV. The load gravity of the UAV may be determined by the UAV' s carrying process, to determine whether the lift generated by the UAV is sufficient to carry the carrying object, and then determine whether there is a need to adjust the propeller blade and the propeller arm. Thereby the load control process of the UAV is more accurate and a blind adjustment is avoided.

As yet another embodiment, the processor controls the propeller arm adjust to a target length and the propeller blade to adjust to the target size, so that the unmanned aerial vehicle controls the propeller blade to rotate to carry the carrying object may specifically be:

determining an initial length of the propeller arm and an initial size of the propeller blade before adjustment;

determining a first adjustment step of the propeller blade according to the target size and the initial size;

determining a second adjustment step of the propeller arm according to the target length and the initial length; and

controlling the propeller blade of the unmanned aerial vehicle to adjust the first adjustment step to the target size and the propeller arm to adjust the second adjustment step to the target length, so that the unmanned aerial vehicle controls the propeller blade to rotate to carry the carrying object.

The propeller blade and the propeller arm may be adjusted in size and length under the control of a drive motor. It is possible to determine a first adjustment accuracy of the propeller blade for each adjustment step driven by the first drive motor, and a second adjustment accuracy of the propeller arm for each adjustment step driven by the second drive motor.

The processor determining the first adjustment step of the propeller blade according to the target size and the initial size may specifically be:

determining a first length of the propeller blade corresponding to the target size, and a second length of a propeller blade corresponding to the target size;

calculating a difference between the first length and the second length to obtain a first difference value; and

calculating a quotient of the first difference value and the first adjustment accuracy, and the sum of the rounded value and the integer 1 is the first adjustment step of the propeller blade.

The processor determines the second adjustment step of the propeller arm according to the target length and the initial length may specifically be:

calculating a difference between the target length and the initial length, to obtain a second difference value; and

calculating a quotient of the second difference value and the second adjustment accuracy, and the sum of the rounded value and the integer 1 is the second adjustment step of the propeller blade.

In the embodiment of the present disclosure, when adjusting the propeller blade and the propeller arm, the first adjustment step may be calculated according to the initial size and the target size of the propeller blade, and the second adjustment step may be calculated according to the initial length and the target length of the propeller arm. By calculating the adjustment step, the propeller blade of the UAV may be controlled to adjust the corresponding first step, and the propeller arm of the UAV may be controlled to adjust to the corresponding second step, to improve the accuracy of the adjustment.

As yet another embodiment, the processor determines the target lift of the unmanned aerial vehicle based on the load gravity may specifically be:

determining a target cruise altitude of the unmanned aerial vehicle; and

calculating the target lift of the unmanned aerial vehicle based on the target cruise altitude and the load gravity of the unmanned aerial vehicle.

Optionally, the target lift of the UAV may be calculated in accordance with the flight altitude conversion coefficient of the UAV, based on the target cruise altitude and the load gravity of the UAV.

In the embodiment of the present disclosure, the lift of the UAV may be related to its cruise altitude, and the target lift of the UAV determined by the cruise altitude may control the calculation process of the target lift to be more accurate. It may make the UAV to generate enough the lift to carry to the target cruise altitude, and avoid the inaccurate flight altitude caused by the insufficient UAV lift caused by the estimation method.

In a typical configuration, a computing device includes one or more processors (CPUs), an input/output interface, a network interface, and a memory. The memory may include a non-permanent memory, a random access memory (RAM), and/or a non-volatile memory in a computer-readable medium, such as a read-only memory (ROM) or a flash RAM. The memory is an example of a computer-readable medium. The computer-readable medium includes permanent and non-permanent, mobile and non-mobile media, which may implement information storage by any method or technology. The information may be a computer-readable instruction, a data structure, a program module, or other data. Examples of computer storage media include, but are not limited to, a phase change RAM (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disk read-only memory (CD-ROM), a digital versatile disk (DVD) or other optical memories, a magnetic tape cartridge, a magnetic tape storage device or other magnetic storage devices or any other non-transmission media, which may be used to store information accessible by a computing device.

Certain words used in the description and claims to refer to specific components. Those skilled in the art will understand that hardware manufacturers may use different terms to refer to the same component. This specification and claims do not use the differences in names as a way to distinguish components, but rather the differences in functions of components as a criterion for distinguishing between components. As used throughout the specification and claims, “comprising” is an open-ended term and should be interpreted as “including but not limited to”. The subsequent description of the specification is a preferred embodiment for implementing the present disclosure, but the description is for the purpose of illustrating the general principles of the present disclosure and is not intended to limit the scope of the present disclosure. The scope of protection of the present disclosure shall be determined by the scope defined by the appended claims.

It is also to be noted that terms “include”, “contain” or any other variants thereof are intended to include nonexclusive inclusions, thereby ensuring that a commodity or system including a series of elements not only includes those elements but also includes other elements which are not clearly listed or further includes elements intrinsic to the commodity or the system. Under the condition of no more restrictions, an element defined by statement “including a/an” does not exclude existence of another element which is the same in a commodity or system including the element.

The above description shows and describes several preferred embodiments of the present disclosure, but as mentioned above, it should be understood that the present disclosure is not limited to the form disclosed herein, and should not be regarded as an exclusion of other embodiments, but can be used for other combinations, modifications, and environments, and can be altered within the scope of the application concept described herein, through the teachings above or related technology or knowledge in the relevant field. Modifications and changes made by those skilled in the art without departing from the spirit and scope of the present disclosure shall all fall within the protection scope of the claims attached to the present disclosure.

1. A load control method based on an unmanned aerial vehicle, wherein the unmanned aerial vehicle comprises: an unmanned aerial vehicle body, a propeller arm with a first end connected to the unmanned aerial vehicle body, a propeller blade connected to a second end of the propeller arm and a processor installed in the unmanned aerial vehicle body; and
wherein a length of the propeller arm is adjustable, and a size of the propeller blade is adjustable;
the method comprising:
determining load gravity of the unmanned aerial vehicle based on a carrying object of the unmanned aerial vehicle;
determining a target lift of the unmanned aerial vehicle based on the load gravity;
determining a target size of the propeller blade and a target length of the propeller arm based on the target lift; and
adjusting the propeller arm to the target length and the propeller blade to the target size, so that the unmanned aerial vehicle controls the propeller blade to rotate to generate lift to carry the carrying object.

2. The method according to claim 1, wherein the determining load gravity of the unmanned aerial vehicle based on a carrying object of the unmanned aerial vehicle comprises:
controlling the propeller blade to adjust to a maximum size and the propeller arm to adjust to a maximum length, so that the unmanned aerial vehicle is in a first carrying state;
utilizing the unmanned aerial vehicle in the first carrying state to carry the carrying object;
determining a first lift of current of the unmanned aerial vehicle; and
determining the load gravity of the unmanned aerial vehicle based on the first lift.

3. The method according to claim 2, wherein the determining the load gravity of the unmanned aerial vehicle based on the first lift comprises:
detecting whether a first carrying height of current of the unmanned aerial vehicle is greater than a preset height threshold value or not;
if yes, determining the load gravity of the unmanned aerial vehicle based on the first lift and the first carrying height;
if not, adjusting a rotation speed of the propeller blade until a second carrying height that is greater than the preset height threshold value is detected.

4. The method according to claim 1, wherein the adjusting the propeller arm to the target length and the propeller blade to the target size, so that the unmanned aerial vehicle controls the propeller blade to rotate to generate lift to carry the carrying object comprises:
determining an initial length of the propeller arm and an initial size of the propeller blade before adjustment;
determining a first adjustment step of the propeller blade according to the target size and the initial size;
determining a second adjustment step of the propeller arm according to the target length and the initial length; and
controlling the propeller blade of the unmanned aerial vehicle to adjust the first adjustment step to the target size and the propeller arm to adjust the second adjustment step to the target length, so that the unmanned aerial vehicle controls the propeller blade to rotate to carry the carrying object.

5. A load control device based on an unmanned aerial vehicle, wherein the control device is used to control an unmanned aerial vehicle and the unmanned aerial vehicle comprises: an unmanned aerial vehicle body, a propeller arm with a first end connected to the unmanned aerial vehicle body, a propeller blade connected to a second end of the propeller arm and a processor installed in the unmanned aerial vehicle body; and wherein a length of the propeller arm is adjustable, and a size of the propeller blade is adjustable;
the device comprising: a processing component, and a storage component connected to the processing component; wherein the processing component comprises one or more processors, the storage component comprises one or more memories, and the storage component is for storing one or more computer instructions for the processing component to call and execute;
wherein the processing component is for:
determining load gravity of the unmanned aerial vehicle based on a carrying object of the unmanned aerial vehicle; determining a target lift of the unmanned aerial vehicle based on the load gravity; determining a target size of the propeller blade and a target length of the propeller arm based on the target lift; and adjusting the propeller arm to the target length and the propeller blade to the target size, so that the unmanned aerial vehicle controls the propeller blade to rotate to generate lift to carry the carrying object.

6. The device according to claim 5, wherein the processing component determining the load gravity of the unmanned aerial vehicle based on the carrying object of the unmanned aerial vehicle specifically is:
controlling the propeller blade to adjust to a maximum size and the propeller arm to adjust to a maximum length, so that the unmanned aerial vehicle is in a first carrying state;
utilizing the unmanned aerial vehicle in the first carrying state to carry the carrying object;
determining a first lift of current of the unmanned aerial vehicle; and
determining the load gravity of the unmanned aerial vehicle based on the first lift.

7. The device according to claim 6, wherein the processing component determining the load gravity of the unmanned aerial vehicle based on the first lift specifically is:
detecting whether a first carrying height of current of the unmanned aerial vehicle is greater than a preset height threshold value or not;
if yes, determining the load gravity of the unmanned aerial vehicle based on the first lift and the first carrying height;
if not, adjusting a rotation speed of the propeller blade until a second carrying height that is greater than the preset height threshold value is detected, determining a second lift of the unmanned aerial vehicle after adjustment, and determining the load gravity of the unmanned aerial vehicle based on the second carrying height and the second lift.

8. The device according to claim 5, wherein the processing component adjusting the propeller arm to the target length and the propeller blade to the target size, so that the unmanned aerial vehicle controls the propeller blade to rotate to generate lift to carry the carrying object specifically is:
determining an initial length of the propeller arm and an initial size of the propeller blade before adjustment;
determining a first adjustment step of the propeller blade according to the target size and the initial size;
determining a second adjustment step of the propeller arm according to the target length and the initial length; and
controlling the propeller blade of the unmanned aerial vehicle to adjust the first adjustment step to the target size and the propeller arm to adjust the second adjustment step to the target length, so that the unmanned aerial vehicle controls the propeller blade to rotate to carry the carrying object.

9. An unmanned aerial vehicle, comprising an unmanned aerial vehicle body, a propeller arm with a first end connected to the unmanned aerial vehicle body, a propeller blade connected to a second end of the propeller arm and a processor installed in the unmanned aerial vehicle body to control the propeller blade to rotate to generate lift to carry a carrying object, wherein a length of the propeller arm is adjustable, and a size of the propeller blade is adjustable;
and wherein a target size of the propeller blade and a target length of the propeller arm are determined according to a target lift determined by load gravity of the unmanned aerial vehicle.

10. The unmanned aerial vehicle according to claim 9, wherein the processor of the unmanned aerial vehicle is further configured to:
determine the load gravity of the unmanned aerial vehicle based on the carrying object of the unmanned aerial vehicle;
determine the target lift of the unmanned aerial vehicle based on the load gravity;
determine the target size of the propeller blade and the target length of the propeller arm according to the target lift; and
adjust the propeller arm to the target length and the propeller blade to the target size, so that the unmanned aerial vehicle controls the propeller blade to rotate to generate lift to carry the carrying object.
